(19) United States
(12) Patent Application Publication
(10) Pub. No.: US 2008/0126391 A1
(43) Pub. Date: May 29, 2008

(54) Grant Management System and Method

(75) Inventors: Ruth Elisabeth Bishop, Grand Rapids, MI (US); Joshua Duane Church, Fenville, MI (US); Laura Johnson Craft, Grand Rapids, MI (US); Mary Elizabeth Greene, Grand Rapids, MI (US); Wendy Suzanne Lewis Jackson, Detroit, MI (US); Catherine Louise Luckert, Grand Haven, MI (US); Mary Barbara McDonald, Muskegon, MI (US); Korrie Suzanne Ottenwess, Grand Rapids, MI (US); Marcia Lynn Rapp, Grand Rapids, MI (US); Diana Rose Sieger, Grand Rapids, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: GRAND RAPIDS COMMUNITY FOUNDATION, Grand Rapids, MI (US)

(21) Appl. No.: 11/564,473

(22) Filed: Nov. 29, 2006

(51) Int. Cl. G06F 7/00; G06F 17/00; G06F 3/00

(52) U.S. Cl. 707/102; 707/104.1; 715/762; 707/E17.005; 707/E17.001

(57) ABSTRACT

A system and method for administering the grant accountability process in which decisions are informed by objective indicators that are scaleable to the community, foundation and grantee levels. Indicator data is entered into a grant management database and objectively analyzed to inform future grant making decisions. Drillable gauges provide a visual representation of the status of each indicator. The gauges are organized into community, foundation and grantee levels to provide a snapshot of the community as a whole, the foundation, and each grantee as in various leadership agenda and priority areas.

### BACKGROUND OF THE INVENTION

The present invention relates to grant management, and more specifically to a system and method for administering the grant accountability process.

Foundations have been established across the country (and the world) to administer the distribution of grant money to non-profit organizations and other organizations operating to promote the public good. Foundations are typically involved in all aspects of grantmaking, including determination of the appropriate recipients of the funds, measuring the success of specific grants, and providing feedback to the grant recipients, to name just a few of the stages in which they are involved.

At this point in time, administration of the grant accountability process is done largely on an ad hoc basis, with each foundation essentially creating its own methods and procedures. In some cases, successful methods for handling one aspect of the process or another will be shared by different foundations, but there is no comprehensive system or method capable of providing overall administration of the grant accountability process beginning with evaluation of grant applicants and continuing through evaluation of grant recipients, the foundation and the community as a whole. Existing methods also suffer from a lack of objective standards for evaluating grant applicants and grant recipients, which can lead to inconsistency and inefficiency.

Foundations, governmental entities and other organizations often track indicators considered to be relevant to the well-being of the community. These indicators are often used outside of the grant making process to evaluate the overall state of a community and to assess overall progress in community-building efforts.

There is a long-felt and unmet need for a method and system for administering the grant accountability process.

### SUMMARY OF THE INVENTION

The aforementioned problems are overcome by a system and method for administering the grant accountability process in which decisions are informed by objective indicators that are scaleable to the community, foundation and grantee levels. In one embodiment, the objective indicators monitor the progress of various grant making priority areas at community, foundation, and grantee levels. Grant proposals are assigned a priority area and associated with one or more indicators from that priority area. Decisions regarding whether and how much to fund each of the grant proposals are made based on past or anticipated future effect on those indicators. Once funded, grantees execute their grant proposals and enter data into a grant management database according to reporting requirements negotiated with the grantee. This data is objectively analyzed going forward to inform future grant making decisions.

In one embodiment, the system includes one or more gauges to provide a visual representation of the status of each indicator. Each gauge may have concern, target and excellence ranges that provide macro characterizations of the status of the corresponding indicator. The gauges are maintained by the system in real-time at the community, foundation and grantee levels, thereby providing a snapshot of the success or failure of the community as a whole, the foundation, and each grantee in the specified priority areas.

In one embodiment, the indicator data that drives the gauges is reliably tracked internally or by outside organizations. In another embodiment, the system allows the grantee to enter indicator data directly into the system so that, once established, the indicators can be maintained without input from the foundation. The system may provide essentially immediate incorporation of the data via the visual gauges. The data may immediately percolate through all relevant gauges.

The present invention provides a relatively simple and effective system and method for managing the grant accountability process. Once a number of initial subject decisions are made, the process is governed essentially through objective standards, thereby providing a high degree of consistency, efficiency and accountability. The system may be easily implemented using conventional computer systems, and may be implemented using a web-based system. Further, the present invention provides a method for leveraging data already being collected by governmental and other organizations in objective decision making steps.

These and other objects, advantages, and features of the invention will be readily understood and appreciated by reference to the detailed description of the current embodiment and the drawings.

### BRIEF DESCRIPTION OF THE DRAWINGS

FIG. 1 illustrates a general overview diagram of the grant management system.

FIG. 2 is a general flowchart of a method of grant management.

FIG. 3 is a detailed flowchart of a method of grant management.

FIG. 4 is an overview diagram of the grant management gauges.

FIG. 5 is a screenshot of a demographics input screen.

FIG. 6 is a screenshot of an activities input screen.

FIG. 7 is a screenshot of an outcome input screen.

FIG. 8 is a screenshot of a demographics report.

FIG. 9 is a screenshot of a activities report.

### DESCRIPTION OF THE CURRENT EMBODIMENT

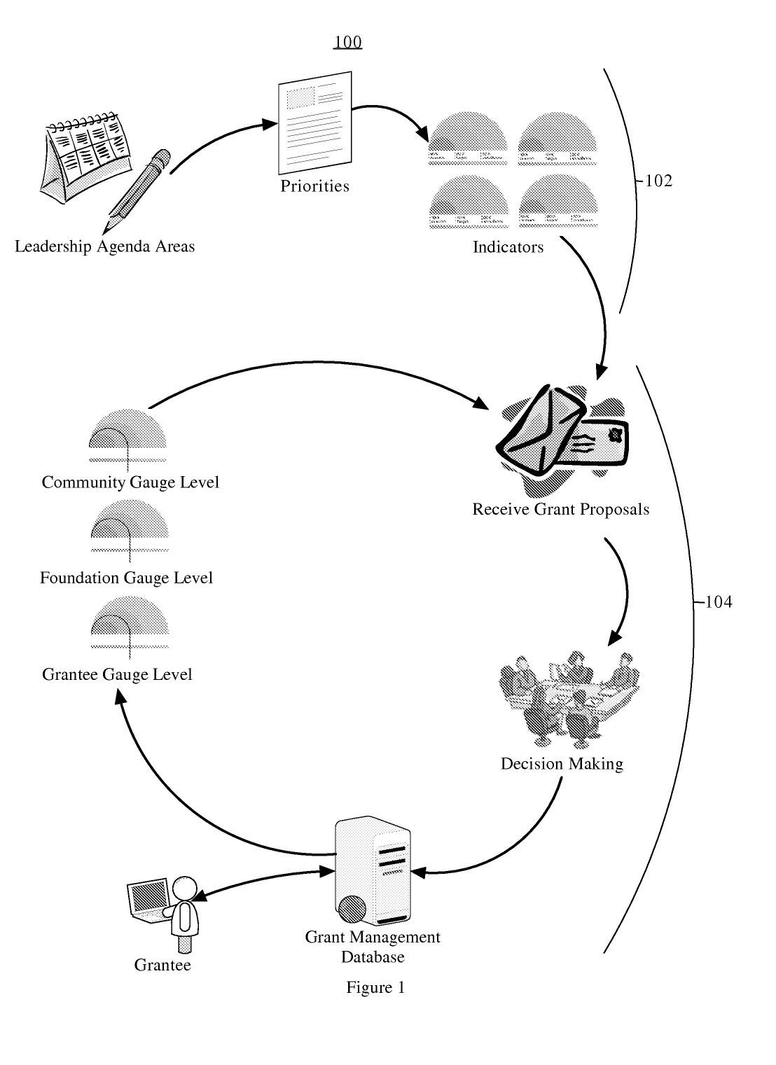

A system for managing the grant accountability process in accordance with one embodiment of the invention is shown in FIG. 1. In this embodiment, the grant management system 100 includes an initial grant management implementation phase 102 and a grant management maintenance phase 104. The grant management implementation phase 102 is where the foundation makes any initial decisions to begin the grant making process that may, but need not be periodically reviewed and revised. The grant management maintenance phase 104 includes the management decisions and tasks for a cycle of the grant accountability process. Generally, but not necessarily, the steps of the grant management system 100 are interchangeably performed by various foundation staff, technicians, officers, board members, evaluators, and in some cases grant candidates, grantees or other third parties.

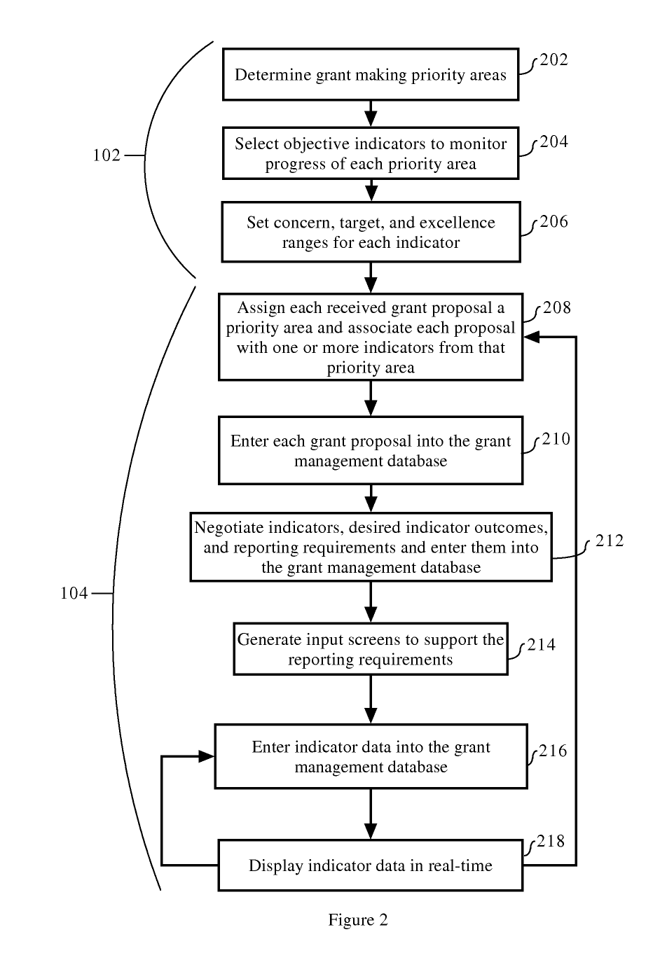

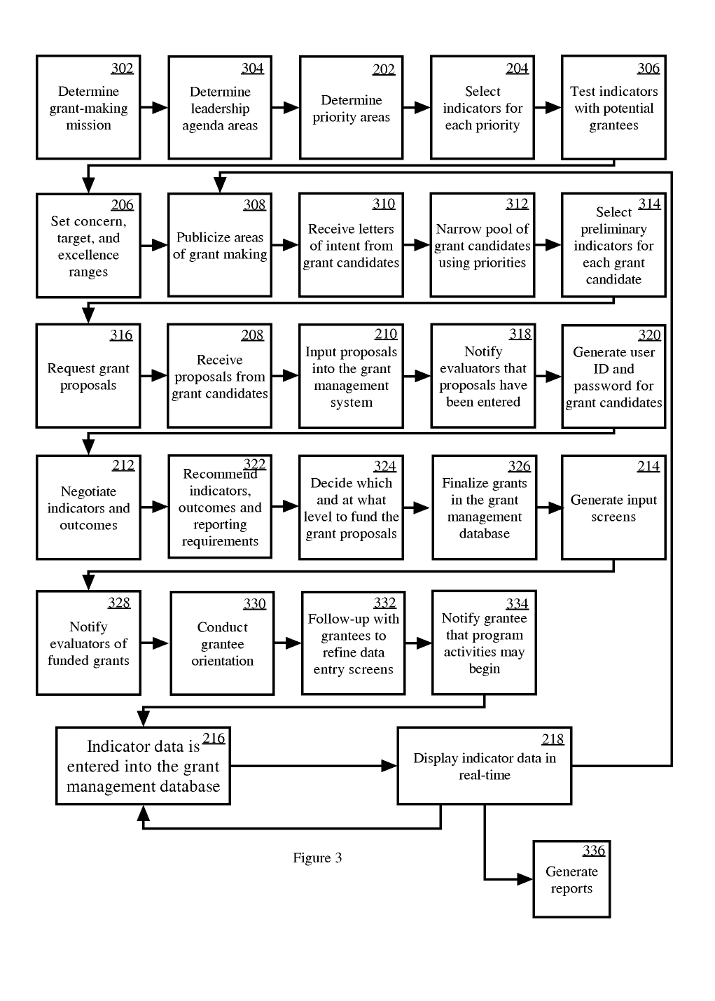

In one embodiment of the grant accountability process, as shown in FIG. 2, the grant management implementation phase 102 includes the steps of determining the grant-making priority areas 202, selecting objective indicators to monitor the progress of each priority area 204, and setting concern, target and excellence ranges for each indicator 206. In alternative embodiments, the grant management implementation phase 102 may include fewer, additional, or different steps. For example, in one embodiment, as shown in FIG. 3, the grant management implementation phase includes the additional steps of determining a grant making mission 302, determining leadership agenda areas 304 and testing the initial indicators with potential grantees 306.

The foundation may begin the grant management implementation phase 102 by reviewing, or developing if necessary, the foundation's mission, vision and values 302. Although subjective and unnecessary, this review may prove helpful to provide a broad starting point which can be used during later steps of the process.

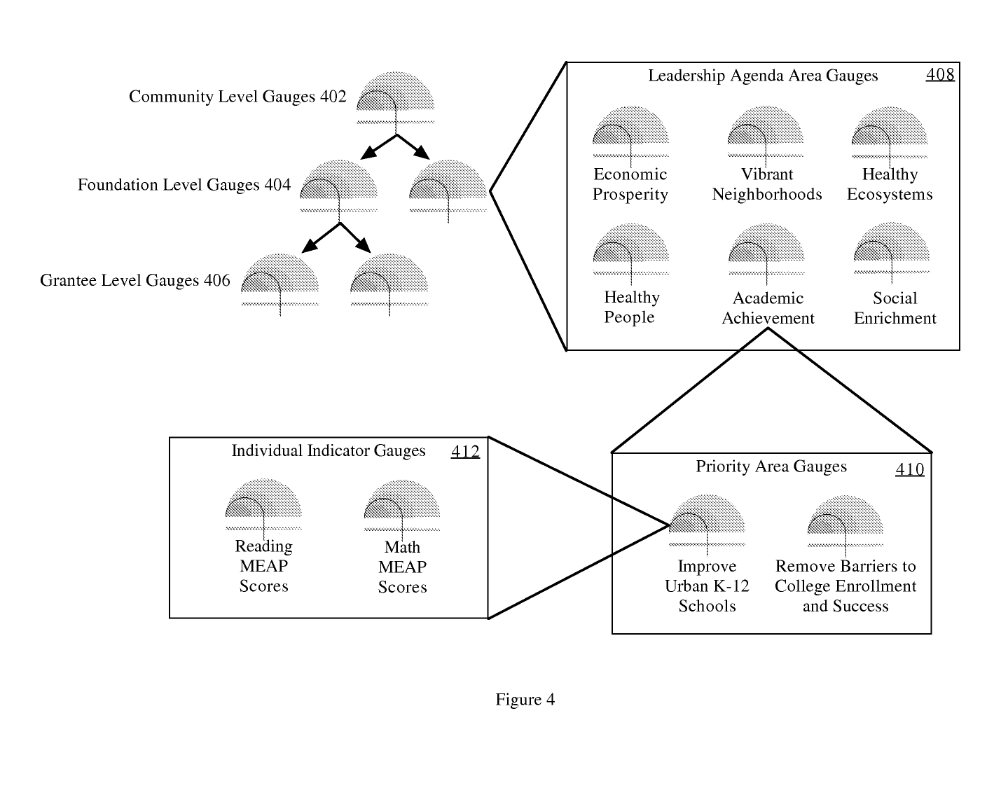

In some embodiments, a plurality of areas each indicative of a grant making priority are established. The areas may be arranged with any number of layers of abstraction. For example, as shown in FIG. 4, in one embodiment there are two layers of abstraction, a broad internal leadership agenda layer 408 and a more narrow grant making priority layer 410. Each layer of abstraction may be referred to as a grant making priority area or a collection of gauges. In other embodiments, additional or fewer abstraction layers exist. For example, in one embodiment there is only a single layer of abstraction, grant making priorities. In another embodiment, there are three layers of abstraction, ranging from broad to narrow.

As noted, in the two abstraction layer embodiment, the foundation develops internal leadership agenda areas to begin to narrow the focus from the broad foundation mission 304. A foundation's internal leadership agenda is typically designed to impact emerging issues in the community. The leadership agenda may be developed through a combination of timely research and meaningful input from knowledgeable community resources. The leadership agenda represents those areas where a foundation will provide a response for complex issues in the community that require a more comprehensive solution. In one embodiment the leadership agenda is revisited and reviewed annually by a foundation's staff and board of trustees. Information used by foundation leaders to determine the leadership agenda may come from (1) analysis of local, state, or national point data; (2) analysis of local trends; (3) the foundation's mission and vision; (4) a gap analysis of what other foundations are doing; (5) an asset inventory that shows where the foundation is well positioned to create an impact; (6) community knowledge data drawn from local, state and national sources; (7) the knowledge base of staff and community members; (8) instinct; or (9) any other appropriate source.

For example, in one embodiment, the foundation leadership agenda areas are (1) economic prosperity; (2) vibrant neighborhoods; (3) academic achievement; (4) healthy people; (5) healthy ecosystems; and (6) social enrichment. The economic prosperity leadership agenda area covers developing resources that allow the community to compete and thrive in a changing economy. The vibrant neighborhoods agenda area covers supporting safe, attractive and self-sufficient communities of residences and businesses. The academic achievement agenda area covers providing quality schools and education for all students. The healthy people agenda area covers promoting personal safety, health behaviors and access to quality healthcare for all. The healthy ecosystems agenda area covers preserving natural resources for the benefit of all people. The social enrichment agenda area covers cultivating an attractive, desirable community that enriches the lives of all people.

In the two abstraction layer embodiment, priority areas for the grant accountability process are selected during the implementation phase and may be reviewed or adjusted periodically 202. Generally, the purpose of the priorities is to narrow the area of grant making focus from the broader leadership agenda areas to specific topics. In an alternative embodiment, grant making priorities are established without regard to the leadership agenda. The same information and criteria used to determine leadership agenda areas may be used in this step. For example, in one embodiment the Grand Rapids Community Foundation's priority area under the leadership agenda area of academic achievement is to improve urban K-12 schools by (1) focusing on math and reading; (2) remove barriers to learning through community supports; and (3) focus on high school reform. A second exemplary priority area is to remove barriers to college enrollment and success. After one or more priority areas are established, each priority is associated with one or more objective indicators to assist in measuring the current status of the priority areas, as well as any effect the foundation's grant decisions have on the priority areas.

In order to monitor grant impact, an indicator or set of indicators is selected for each priority area 204. Indicators are composed of specific sets of data that are monitored to show progress towards desired outcomes or that an outcome has been achieved. Various criteria may be used alone or in combination for selecting indicators, such as: (1) the availability of indicator data; (2) the accessibility of indicator data; (3) the reliability of indicator data; (4) the validity of indicator data; (5) the scalability of indicator data; (6) the cost of obtaining indicator data; (7) literature review on strengths and pitfalls of data being considered; (8) capacity for collecting indicator data; (9) feedback related to the indicator data; and (10) any other appropriate criteria. For example, in one embodiment, the foundation indicators under the leadership agenda area of academic achievement and the priority area of improve urban K-12 schools—remove barriers to learning through community supports include Grand Rapids Public Schools MEAP (Michigan Education Assessment Program) reading scores and Grand Rapids Public Schools MEAP math scores.

Indicators need not be limited to test scores though, essentially any concrete and quantifiable data may be used as an indicator. For example, indicators may be crafted from housing market data, hospital data, or library data, just to name a few examples. Although an indicator generally needs to be concrete and quantifiable, it need not be directly indicative of progress in a priority area, a simple correlation is enough. For example, a priority area under the leadership agenda area of healthy people might be to diminish adolescent obesity. An indicator of the progress of this priority area need not be a literal measurement of the percentage of adolescents who are obese. Such an indicator may not be readily available or may be too costly to measure consistently and effectively. Instead a valid indicator may be the percentage of high school students who have obtained the Presidential Physical Fitness Award or the percentage of students who purchase a nutritional lunch from their school on a daily basis. Regardless, it is generally up to the foundation to make a subjective determination that the objective indicators are sufficiently correlated with the priority areas they are deemed to measure. Also, it is possible that one indicator may be helpful in measuring the progress of multiple priority areas. Once the initial indicators are selected, any historical indicator data may be populated into a grant management database to allow the starting status of the indicator to be evaluated.

Optionally, the foundation may host a discussion with community representatives to explore possible indicators or otherwise test the initially selected indicators 306. The indicators may then be revised based on any feedback or test results. For example, the foundation in one embodiment asks community representatives to attend a meeting to discuss indicators under the vibrant neighborhoods leadership agenda area. The foundation may have been considering property citations as an indicator under this area. Based on feedback from individuals who attend this meeting, the foundation learns that increases in the number of property citations are more likely to be related to city staffing changes than improvements in neighborhoods. As a result, the foundation may decide not to use property citations as an indicator. In one embodiment, the grant management database stores comments related to the indicators under consideration for future use or other foundations to consider.

Once the initial indicators have been selected, a series of ranges or thresholds may be set to simplify the evaluation and tracking of the indicators 206. In one embodiment, the indicators are displayed virtually using a number of linked gauges each broken into three ranges: a concern range, a target range and an excellence range. The concern range signifies the need to take action on the issues related to the indicator. The target range signifies a level of performance that the community can be comfortable with. The excellence range signifies that the community is performing as a leader on issues related to the indicator. The criteria used to assist in the selection of ranges includes: (1) current performance; (2) geographic comparisons of the same indicator; (3) trend data; (4) performance of acclaimed programs; (5) previously set standards, such as those set by community groups or the government; or (6) any other appropriate criteria. For example, in the current embodiment, the foundation set the following ranges for the MEAP reading score indicator:
Concern Range: 0-79% of student met or exceeded MEAP Reading Standards
Target Range: 80-89% of students met or exceeded MEAP Reading Standards
Excellence Range—90-100% of students met or exceeded MEAP Reading Standards

Once the implementation phase is complete, any of the steps or decisions made during the implementation phase may be reviewed or adjusted at any time or periodically at set intervals. The gauges, even before the grant accountability process has begun, are indicative of the current status of the community.

In one embodiment, as shown in FIG. 2, the grant management maintenance phase 104 includes the steps of assigning each received grant proposal a priority area and associating each proposal with one or more indicators from that priority area 208, entering each grant proposal into the grant management database 210, negotiating indicators, desired indicator outcomes, and reporting requirements for each funded grant proposal and entering them into the grant management database 212, programming input screens to support the reporting requirements 214, entering indicator data into the grant management database 216, and displaying the indicator data in real time 218. In alternative embodiments, the grant management maintenance phase may include fewer, additional, or different steps. For example, in one embodiment, as shown in FIG. 3, the grant management maintenance phase includes the additional steps of publicizing areas of grant making 308, receiving letters of intent from grant candidates 310, narrowing the pool of grant candidates based on the letter of intent 312, selecting preliminary indicators for each grant candidate 314, requesting proposals that specify desired indicator outcomes 316, notifying evaluators that proposals have been entered 318, generating user ID and password for each grantee candidate 320, recommending final indicators, outcomes, and reporting requirements 322, deciding which and at what level to fund the grant proposals 326, finalizing funded proposals in the grant management system 328, notifying evaluators that the funded grants have been finalized 330, orienting grantees to the grant management system 332, conducting follow-up with grantees to refine input screens 334, notifying the grantees that program activities may begin 336 and generating reports 338.

Optionally, the grant management system maintenance phase 104 may begin with publicizing the areas of grant making 308. Information may be distributed to the community, including potential grantees, that explains the foundation's leadership agenda and priority areas, what will and will not be funded, and how to apply for funding among other things. As the indicator gauges shift between the concern, target and excellence ranges, priority areas for funding may change and publicity efforts may be altered accordingly. Publication techniques may vary. For example, avenues for publicity include: hosting grant workshops, the Internet, word of mouth via foundation staff, and essentially any other suitable publication technique. In addition, in some embodiments, there is no need to actively publicize the areas of grant making, instead it is possible to rely on grant candidates to seek out and submit proposals to the foundation on their own accord.

In some embodiments, the foundation asks the grant candidates to submit a letter of intent 310. The purpose of the letter of intent is for the foundation to get their first glimpse of what the proposed program will be. The letter of intent is also an opportunity to begin a conversation between the grantee and the foundation about where the proposed project fits within the foundation priorities. In one embodiment, the letter of intent includes (1) a statement of the problem or need and an explanation of how it will be addressed; (2) a brief description of anticipated achievements or outcomes; (3) estimated costs for the project or activity; (4) the amount to be assumed by the grant recipient, other organizations, and the amount requested from the foundation; (5) proof of charity status; and (6) contact information. In some embodiments, grant candidates are required or encouraged to submit additional, different or less information. In some embodiments, grant candidates are not permitted to submit a letter of intent and instead may only submit a full fledged grant proposal.

If letters of intent are requested, the foundation assesses each letter of intent as it is received by determining if the proposed programs fit within one of the foundation's priorities 312. If more information is needed, the foundation contacts the grant candidate. If it is determined that the program being proposed is a fit with the priorities, the foundation will make a recommendation for the grant candidate to move on to the next stage of the process. For example, Reading Roundup is an after school program designed to provide one-on-one reading instruction to elementary school students. When the foundation receives a letter of intent for this program, it determines that this program fits under the leadership agenda area of academic achievement and the priority area of improve urban K-12 schools—remove barriers to learning through community supports. Because of the fit, the program advances to the next step of the grant making process. In a contrasting example, a letter of intent from a local camp asks for money to support summer programming. The foundation reviews the letter of intent, talks with the camp leaders and can not see a relationship between the camp services and any of the foundation's leadership agenda areas, therefore the camp does not move to the next step of the grant making process. In the current embodiment this determination is made by the foundation based on their priority areas. However, in alternative embodiments other criteria may be used. For example, the foundation may consider the community leadership agenda and priority areas as a whole in order to decide whether or not to fund the grant. In another embodiment, the foundation may consider other foundations' leadership agenda areas and if applicable, suggest the grant candidate submit the grant proposal to another foundation.

Optionally, preliminary outcomes and indicators for each grant candidate may be selected based on their letter of intent 314. The foundation identifies one or more indicators from the priority area that they fit into for each grant candidate. Eventually, these indicators will be used to measure the progress and performance of individual grant projects. Before grant candidates are asked to submit a full grant proposal, foundation staff identifies possible indicators and negotiates with the grant candidate to verify a fit. In selecting indicators, the foundation chooses an indicator from the list that meaningfully captures the key changes or results that the project wishes to achieve. This effort will ensure that each grant proposal contains measurable outcomes and that the grantee is committed to pursuing those outcomes over the course of their grant. Continuing with the example described above, Reading Roundup may be assigned the indicator of MEAP reading scores under the academic achievement leadership agenda area and the priority area of improve urban K-12 schools—remove barriers to learning through community supports.

If preliminary indicators are assigned, proposals that specify desired outcomes of those indicators may be requested from the grant candidates 316. The foundation staff asks for a proposal from each grantee that addresses their assigned indicators and outcomes. If grant candidates do not send letters of intent, they may initially assign an appropriate set of indicators themselves and specify the desired outcomes of those indicators in their grant proposal or ignore this aspect altogether. The grantee and foundation may negotiate for different outcomes and indicators if either believes the preliminary assignment is not a good fit. By preparing a proposal that includes the finalized outcomes and indicators, the grant candidates are committing to use funding in ways that address those areas. For example, the foundation requests a proposal from the Reading Roundup program or agency director. The foundation asks any questions left from the preliminary outcome and indicator selection process. This program was assigned the indicator of MEAP reading scores under the academic achievement leadership agenda area and the priority area of improve urban K-12 schools—remove barriers to learning through community supports. After confirming the correct fit for the leadership agenda and priority areas, or agreeing on different areas, Fifteen Peals and Promise staff agrees to submit a proposal.

Grant candidates submit requested proposals in hard copy or through an on-line system 208. Foundation staff forwards the proposals to foundation evaluators and technical staff. The technical staff performs any necessary preliminary coding for each grant candidate, based on the preliminary outcomes and indicators, and information included in the proposal. For example, Reading Roundup submits a proposal through the online application process. The online system notifies foundation staff at the time of submission. After foundation staff have read and verified the proposal as meeting preliminary agreements, they forward the proposal to the technical staff. The technical staff creates the preliminary screens that will allow foundation staff to begin initial setup for Reading Roundup. It will also allow the Reading Roundup program staff to work with the evaluator and technical staff to create the actual screens they will use for data entry if they are awarded a grant. In alternative embodiments, the online grant application process automatically records the appropriate information in the grant management database and generates any necessary information and data entry screens based on information entered by the grantee at the time of submission.

Foundation staff enters basic information about the grant candidates into the grant management database 210. This information may be entered directly into the grant management database or through the use of a grant proposal interface. In one embodiment, the grant candidates enter the basic information into the grant management database during the online grant application process using a grant proposal interface web page. This information may include contact information for the organization, the adaptive leadership agenda area and priority area assigned to the grantee, preliminary indicators, and desired outcomes. For example, Reading Roundup may submit a reasonable grant proposal that shows them to be a good fit for the foundation's funding priorities. Foundation staff puts the proposal into the grant management database and verifies the basic organizational information.

Optionally, the grant management system automatically notifies the appropriate person at the foundation, typically a leadership agenda area evaluator, that a new grant has been entered into the grant management system 318. In one embodiment, this notification function sends an email alert to the evaluator of a particular leadership agenda area that a new grant candidate is in the system. For example, Reading Roundup is assigned to the academic achievement leadership agenda area, so the evaluator for this area is notified when their information is entered in the system.

Once basic information about grant candidates is entered into the grant management system, technical staff may configure a user name and password for a representative of the candidate organization to use in accessing grant management system 320. For example, Reading Roundup is entered in the grant management database and foundation technicians assign them one user name and password, which can be used by anyone on the Reading Roundup's staff to access the grant management system. After a user name and password are created for the grant candidate, the information may be emailed to foundation staff and the evaluator, for use in preparing orientation documents.

The foundation may conduct a site visit to negotiate the indicators, desired indicator outcomes, and reporting requirements in the grant proposal 212. This negotiation process may be similar to the preliminary negotiation process described above and is likely the last chance for the grant candidate to submit input before a decision on the grant proposal is made. In some cases, negotiation is unnecessary, for example, if the foundation agrees with the selected indicators, desired indicator outcomes and reporting requirements that the grant candidate has chosen. If a grant proposal does not address the reporting requirements, a standard set of reporting requirements may be used. In alternative embodiments, the reporting requirements, such as for example how often and how much indicator data needs to be entered into the grant management database may be negotiated during the site visit.

The foundation may internally discuss and make final recommendations of indicators, desired indicator outcomes, and reporting requirements for each grant candidate 322. Final indicators are selected based on what will yield the information needed to show impact in the foundation priorities and ultimately the leadership agenda areas, the grant proposal, any negotiations with the grantee, and essentially any other relevant information available to the foundation. For example, Reading Roundup falls within the academic achievement agenda area, and within that, the improve urban K-12 schools by removing barriers to learning priority area. To measure impact, the foundation internally recommends the MEAP reading test, which the grant proposal suggested, as the sole indicator. The foundation also recommends that the program will be responsible for entering the MEAP reading scores into a grant management input screen on a periodic basis.

After reviewing the gauges and how the grant candidates fit within the grant management system, the foundation makes a recommendation to fund or not fund each grant, and at what level to fund 324.

In one embodiment, the gauges are scalable between community levels and drillable between grant making priority layers of abstraction. For example, in one embodiment, as shown in FIG. 4 the gauges are organized into three community levels: community level 402, foundation level 404, and grantee level 406. In alternative embodiments, the number of community levels may vary. In an alternative embodiment, there are only two community levels: a foundation level and a grantee level. In another embodiment, there is only one community level, a grant program level. In the current embodiment with three community levels, the community has a gauge, each foundation has a gauge, and each grantee is represented with a gauge. In this embodiment, drilling and scaling the gauges yields gauges associated with the scaled community level and the drilled abstraction layer. For example, as shown in FIG. 4, scaling to the foundation level 404 and drilling into one of the foundation gauges reveals the gauges for the leadership agenda area abstraction layer 408 associated with that foundation: (1) Economic Prosperity, (2) Vibrant Neighborhoods, (3) Academic Achievement, (4) Healthy People, (5) Healthy Ecosystems, and (6) Social Enrichment. The gauges are specific to the particular community, foundation, or grantee gauge that is being drilled. The scaleable and drillable gauges thereby provide a snapshot of the success or failure of the community as a whole, the foundation, and each grantee.

Continuing with the example, drilling into the Academic Achievement gauge reveals a separate gauge for each of the priority area gauges 410: (1) improve urban K-12 schools, and (2) remove barriers to college enrollment and success. Drilling into the priority area to improve urban K-12 schools leads to the actual indicator gauges 412: (1) MEAP reading scores, and (2) MEAP math scores. Any of the gauges at the community, foundation, or grantee level may be drilled down all the way to the indicator gauges.

The above examples are crafted within the community, foundation and grantee level framework and the agenda area, priority area and indicator abstraction layer framework. However, it would be understood by one skilled in the art that the number of grant making priority abstraction layers and community levels may be varied. For example, there could be an additional community level of grant programs or the agenda area abstraction layer could be removed entirely. In an embodiment with a grant programs level, the grantee level includes a gauge for each grantee, which indicates the overall status of all of that grantee's grant programs, and scaling to the grant program abstraction level reveals a gauge for each individual grant program.

The organization and relationship of gauges may vary. In one embodiment, the status of each of the child gauges factors in equally to determine the status for the parent gauge, however this need not be the case, in alternative embodiments parent gauges may be weighted or calculated differently.

An example of the above described analysis is where the foundation reviews the Reading Roundup proposal and the current status of the gauges and finds that they are a fit with the academic achievement leadership agenda area. The foundation also considers the status of the other leadership agenda areas and priority areas, as well as how the other grant proposals address these areas.

The foundation decides to fund the program at the full level requested in the proposal. In other embodiments, the foundation is not limited to considering whether a particular grant candidate is a good fit for this particular foundation leadership agenda area or priority area. In one embodiment, the foundation considers how a particular grant candidate would fit in the community, regional or national leadership agenda or priority areas.

Any corrections to the grantee information in the grant management database may be made 326. Such corrections might include changing: the foundation personnel assigned to the grant, the leadership agenda area the grant is assigned, the award start date, or any other information in the grant management database. For example, Reading Roundup is awarded a grant for their requested amount, however, the foundation assigns a different foundation officer to that grant. The foundation makes this change in the grant management database.

Once the grants have been awarded, input screens or interfaces to support the reporting requirements are generated or programmed 214. Generally, four interfaces are generated: a client information interface, an activity interface, an outcome interface and a narrative interface. Additional, fewer, or different screens may be used to support the reporting requirements. In one embodiment, the interfaces are web pages that may be hosted by the foundation or a third party and are accessible by the foundation and grantee over the internet. The interfaces may also be programmed and incorporated into an offline application. In one embodiment, the grant management database includes all of the necessary information to automatically generate the four interfaces using a template. In an alternative embodiment, each interface is programmed by a foundation technician.

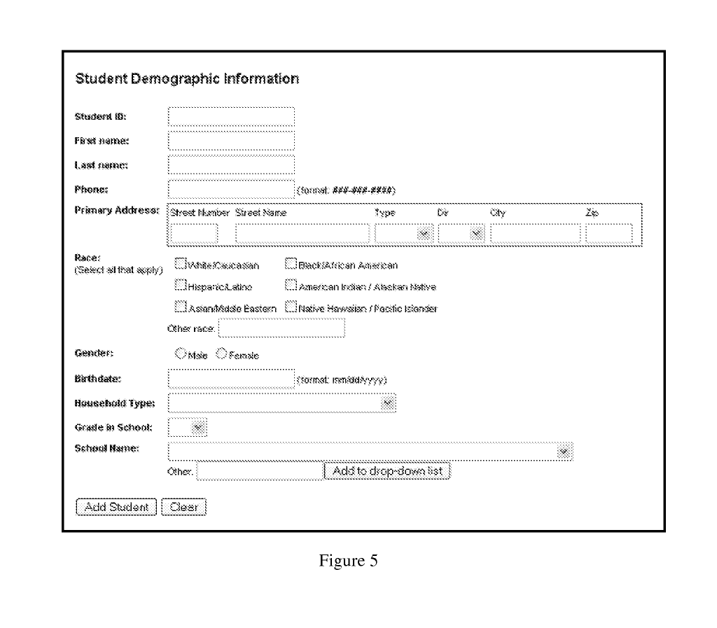

The client information interface of the current embodiment is designed to capture the demographics of the target audience to be served by the grantee. For example, as shown in FIG. 5, the client information input screen for the Reading Roundup program includes input fields for student ID, name, phone number, address, race, gender, birthday, household type, grade, and school name. The fields in other input screens may vary depending on the particular grant program the screen is being designed for.

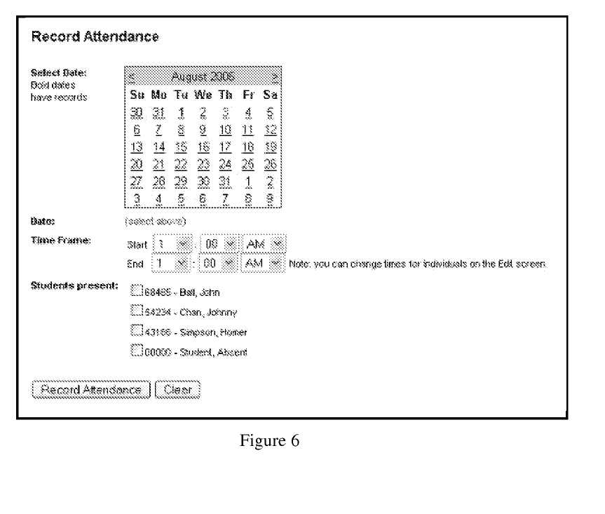

The activity interface of the current embodiment is designed to capture data related to the services provided by the grantee. For example, as shown in FIG. 6, the activity input screen for the Reading Roundup program includes input fields for date, time frame, and the students present. This activity input screen is merely exemplary, other activity input screens may include different fields, such as hours of training and number of participants.

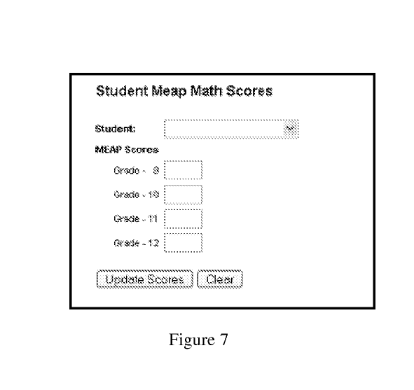

The outcome interface of the current embodiment is designed to capture the changes that occur as a result of grantee activities. For example, as shown in FIG. 7, the outcome input screen for the Reading Roundup program includes input fields for selecting a student and entering their MEAP scores each year. Other outcome input screens may include different fields, such as fields for different indicators, for example price of rent, property value, or other housing market data.

The narrative interface of the current embodiment is designed to capture a grantee narrative of the grant program experience. For example, the narrative input screen may include fields asking (1) the grantee to describe how the terms of the grant program are being/were met; (2) to share any success stories resulting from the grant program; (3) what did not go as expected, and what would the grantee have done differently; (4) will the program continue at its current service level; and (5) any suggestions.

Optionally, the grant management system notification function may send an email alert to the evaluator of a particular leadership agenda area that a grant has been awarded or that input screens have been generated and are available 328. For example, Reading Roundup is assigned to the academic achievement leadership agenda area, so the evaluator of that area is notified when a grant has been awarded to this organization and when the input screens are available.

Optionally, the foundation may conduct grantee orientation sessions to orient the grantees to the grant management system 330. The purpose of the grant management orientation sessions are to introduce the purpose and benefits of the grant management system, conduct a system walk-through, finalize the selection of grant management indicators for the grantee, and provide grantees with instructions for accessing the system. The executive director and the program manager from the organization that received the grant should, but need not necessarily attend. Topics covered in the orientation may include: (1) explanation of the purpose of the grant management system; (2) explanation of the benefits of the grant management system; (3) an explanation of the indicators and gauges; (4) confirmation of the grantee's priority area; (5) confirmation of the grantee's indicators; (6) a walkthrough of the various grantee input screens; and (7) confirmation or discussion of the reporting requirements.

The evaluator may send a follow-up email to each of the grantees after orientation 332. The primary purpose of the email is to begin any work that needs to be completed before the grantee can start entering data into their grant management input screens. For example, if the grantee needs to sign a scope agreement.

After all input screens have been generated, and optionally reviewed for accuracy, the foundation may contact the grantee and confirm that the input screens are satisfactory to support the reporting requirements 334.

As the grant program is executed, indicator data is entered into the grant management database via the interfaces. For example, after each session of the Reading Roundup program where one-on-one reading instruction is provided to elementary students, data is entered into the grant management database using one or more of the client info, activity data, outcome data, and narrative report interfaces.

The grant management gauges, which may be viewed on a web page or other application, move as a result of the data that is entered into the grant management database. For example, each year the students MEAP scores are entered into the grant management database using the outcome data input screen and as a result the gauge move essentially in real time because they are based on the data present in the grant management database. In another example, the indicator data is updated to the grant management database on an hourly or daily basis.

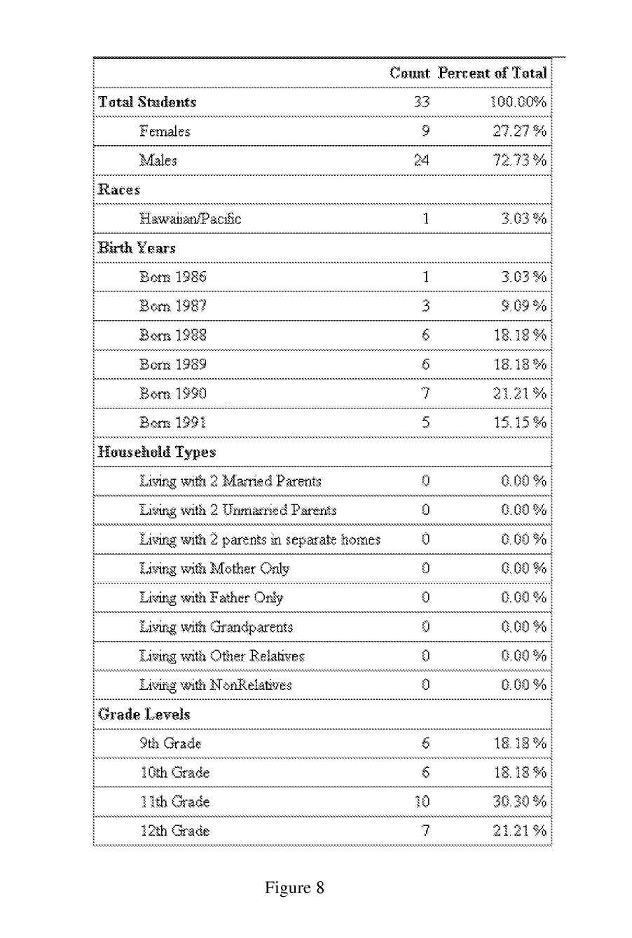

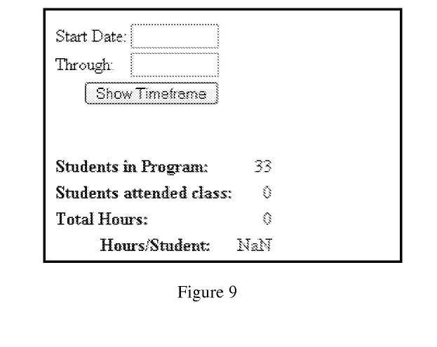

In addition to displaying the indicator data in real-time via gauges, various reports may be generated from the grant management database. For example, in the current embodiment, a demographics report and an activity report may be generated. An exemplary demographics report is shown in FIG. 8 and includes a breakdown of the information entered into the client information input screen. An exemplary activity report is shown in FIG. 9 and includes a breakdown of the information entered into the activity input screen. In an alternative embodiment, graphs and charts representing the data in the demographics report or activity report may be generated.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the,” or “said,” is not to be construed as limiting the element to the singular.

The embodiments of the invention in which an exclusive property or privilege is claimed are defined as follows:

1. A method for administering the grant accountability process comprising:
establishing a community with three levels;
establishing a plurality of areas each indicative of a grant making priority, wherein said areas are arranged with at least two layers of abstraction;
associating a plurality of indicators with each of said areas;
maintaining a grant management database with indicator data;
displaying a plurality of gauges providing a visual representation driven by said indicator data, wherein said gauges are scalable between said community levels and said gauges are drillable between said levels of abstraction of said areas and said indicator data.

2. The method for administering the grant accountability process of claim 1 further comprising associating each of said indicators with a concern range, a target range, and an excellence range.

3. The method for administering the grant accountability process of claim 1 wherein said three levels of said community include a community level, a foundation level, and a grantee level.

4. The method for administering the grant accountability process of claim 1 further defining said establishing said plurality of areas, wherein said areas are arranged with at least three layers of abstraction: a community abstraction layer, a leadership agenda layer and a priority layer.

5. A method for administering the grant accountability process comprising:
determining a plurality of grant making priority areas;
selecting a plurality of objective indicators to monitor the progress of each of said plurality of grant making priority areas;
setting a concern, target, and excellence range for each objective indicator;
receiving a plurality of grant proposals identifying one of said plurality of grant making priority areas from a plurality of grant candidates;
associating each of said plurality of grant proposals with one or more indicators from said identified grant making priority area;
entering each grant proposal including said identified priority area and said one or more associated indicators into a grant management database;
displaying a plurality of drillable and scalable gauges that are updated in real time, wherein said plurality of gauges provide a visual representation of the status of each indicator;
analyzing said drillable and scalable gauges to assist in deciding which grant proposals to fund;
entering indicator data for each indicator associated with said funded grants into the grant management database;

6. The method for administering the grant accountability process of claim 5 wherein said gauges are scalable to community, foundation and grantee levels, wherein each of said community, foundation and grantee levels is drillable to a plurality of leadership agenda area gauges each of which are drillable to a plurality of priority area gauges each of which are drillable to at least one indicator gauge.

7. The method for administering the grant accountability process of claim 5 further comprising:
negotiating reporting requirements for each grant proposal; and
generating input screens to support said reporting requirements for each grant proposal; and
wherein said entering indicator data is done according to said reporting requirements.

8. The method for administering the grant accountability process of claim 5 further comprising:
negotiating desired indicator outcomes; and
said analyzing includes analyzing said desired indicator outcomes with respect to actual indicator outcomes.

9. The method for administering the grant accountability process of claim 5 wherein said objective indicators are selected from data that is reliably tracked by the community.

10. The method for administering the grant accountability process of claim 5 wherein a grantee is responsible for entering said indicator data into the grant management database.

11. The method for administering the grant accountability process of claim 5 further comprising entering historical indicator data for each of said selected indicators.

12. A system for administering the grant accountability process comprising:
a grant management database;
a grant proposal interface for entering a plurality of grant proposals into said grant management database;
a client information interface for each grant proposal for entering demographic data related to a target audience of said grant proposal into said grant management database;
an activity interface for each grant proposal for entering grant program activity data into said grant management database;
an outcome interface for each grant proposal for entering indicator data into said grant management database;
a narrative interface for each grant proposal for entering grantee narrative data into said grant management database; and
a display for displaying a plurality of drillable and scaleable gauges that inform decisions regarding said grant proposals in said grant management database, wherein said gauges are driven by said indicator data in said grant management database.

13. The system for administering the grant accountability process of claim 12 wherein said display includes a client information report and an activity report.

14. The system for administering the grant accountability process of claim 12 wherein said gauges are scalable to community, foundation and grantee levels, wherein each of said community, foundation and grantee levels is drillable to a plurality of leadership agenda area gauges each of which are drillable to a plurality of priority area gauges each of which are drillable to at least one indicator gauge.

15. A method for administering the grant accountability process comprising:
determining a plurality of leadership agenda areas;
determining a plurality of grant making priority areas for each of said plurality of leadership agenda areas;
selecting a plurality of objective indicators that monitor the progress of each of said plurality of grant making priority areas;
setting a concern, target, and excellence range for each of said revised objective indicator;
publicizing said leadership agenda areas and said grant making priority areas;
receiving a plurality of grant candidate letters of intent;
associating a foundation suggested indicator and a foundation suggested indicator outcome with each letter of intent;
requesting a grant proposal;
receiving a plurality of grant proposals, wherein each of said grant proposals identifies a grant candidate suggested indicator and a grant candidate desired indicator outcome;
entering each grant proposal into a grant management database, wherein said grant proposal includes said foundation suggested indicator, said grant candidate suggested indicator, said foundation suggested desired indicator outcome and said grant candidate suggested desired indicator outcome;
negotiating with each of said grant candidates a final indicator and a final desired indicator outcome from said foundation suggested indicator, said grant candidate suggested indicator, said foundation suggested desired indicator outcome and said grant candidate suggested desired indicator outcome;
recommending said final indicator and said final desired outcome;
displaying a plurality of drillable and scalable gauges that are updated in real time, wherein said plurality of gauges provide a visual representation of the status of each final indicator;
analyzing said drillable and scalable gauges to assist in deciding which grant proposals to fund; and
entering indicator data for each indicator associated with said funded grants into the grant management database.

16. The method for administering the grant accountability process of claim 15 wherein said gauges are scalable to community, foundation and grantee levels, wherein each of said community, foundation and grantee levels is drillable to a plurality of leadership agenda area gauges each of which are drillable to a plurality of priority area gauges each of which are drillable to at least one indicator gauge.

17. The method for administering the grant accountability process of claim 15 further comprising:
negotiating reporting requirements for each grant proposal; and
generating input screens to support said reporting requirements for each grant proposal; and
wherein said entering indicator data is done according to said reporting requirements.

18. The method for administering the grant accountability process of claim 15 wherein said objective indicators are selected from data that is reliably tracked by the community.

19. The method for administering the grant accountability process of claim 15 wherein a grantee is responsible for entering said indicator data into the grant management database.

20. The method for administering the grant accountability process of claim 15 further comprising entering historical indicator data for each of said selected indicators.
